(19) United States
(12) Patent Application Publication
(10) Pub. No.: US 2026/0102236 A1
(43) Pub. Date: Apr. 16, 2026

(54) TOOTHBRUSH HEAD

(71) Applicant: Shenzhen Jinlingzi Intelligent Technology Co., Ltd., Shenzhen (CN)

(72) Inventors: Penglong Shao, Dongguan (CN); Qingshan Li, Guang'an (CN)

(21) Appl. No.: 19/035,659

(22) Filed: Jan. 23, 2025

(30) Foreign Application Priority Data
Oct. 12, 2024 (CN) 2024224629137
Oct. 12, 2024 (CN) 2024224632549

(51) Int. Cl. A61C 17/22; A46B 3/04; A46B 9/04; A46B 13/02; A61C 17/34

(52) U.S. Cl. CPC A61C 17/222; A46B 3/04; A46B 9/04; A46B 13/023; A61C 17/3481; A46B 2200/1066

(57) ABSTRACT

The present disclosure relates to a toothbrush head, including a brush head member and a connector. The brush head member includes a hard brush handle and brush bristle assemblies connected to the hard brush handle. A connection hole is formed in an end of the hard brush handle facing away from the brush bristle assemblies. The connector includes a soft clamping member and a connection body. The connection body is accommodated in the connection hole and fixedly connected to the hard brush handle. A shaft hole configured to insert a motor shaft is formed in the connection body. The soft clamping member is connected to the connection body, at least partially protrudes into the shaft hole, and abuts against the motor shaft.

### TECHNICAL FIELD

The present disclosure relates to the technical field of oral care products, and in particular, to a toothbrush head.

### BACKGROUND

As people's living standards improve and their understanding of oral hygiene maintenance methods deepens, more and more people are using electric toothbrushes instead of conventional toothbrushes. There are two types of electric toothbrushes: vibrating and rotating. The vibrating type is the mainstream product on the market, which mainly cleans the oral cavity through high-frequency vibration of a toothbrush head.

A motor capable of generating high-frequency vibration is generally disposed in a main body of the electric toothbrush, and a motor shaft is connected to a toothbrush head to transmit the vibration to the toothbrush head. The toothbrush head is usually detachably connected to the motor shaft to facilitate periodic replacement of the toothbrush head. This detachable connection structure is an important aspect of the electric toothbrush field that needs to be studied and improved in detail. On one hand, if the detachable connection structure is too tight, it may be inconvenient to disassemble; and on the other hand, if the detachable connection structure is not tight enough, the toothbrush head may easily become loose after a period of use and may not be able to reliably transmit the vibration.

As disclosed in patent CN114760955A, a spring is mounted in a brush handle of a toothbrush head, and the spring is employed to fix a motor shaft and a brush handle and transmit vibration. However, this brush head structure has relatively high costs, and inconvenient assembly of the spring on the toothbrush head.

### SUMMARY

On this basis, it is necessary to provide a toothbrush head for at least one of the problems mentioned above.

Provided is a toothbrush head, including:
a brush head member, including a hard brush handle and brush bristle assemblies connected to the hard brush handle, where a connection hole is formed in an end of the hard brush handle facing away from the brush bristle assemblies; and
a connector, including a soft clamping member and a connection body, where the connection body is accommodated in the connection hole and fixedly connected to the hard brush handle, a shaft hole configured to insert a motor shaft is formed in the connection body, and the soft clamping member is connected to the connection body, at least partially protrudes into the shaft hole, and abuts against the motor shaft.

### BRIEF DESCRIPTION OF THE DRAWINGS

To describe the technical solutions in the embodiments of the present disclosure or in the prior art more clearly, the following briefly describes the drawings required for describing the embodiments or the prior art. Apparently, the drawings in the following description show merely some embodiments of the present disclosure, and a person of ordinary skill in the art may still derive other drawings from these drawings without creative efforts.

FIG. 1 is a schematic diagram of a toothbrush head according to a first embodiment of the present disclosure;

FIG. 2 is an exploded view of a toothbrush head shown in FIG. 1;

FIG. 3 is another exploded view of a toothbrush head shown in FIG. 1;

FIG. 4 is a schematic diagram of a connector of a toothbrush head according to a first embodiment of the present disclosure;

FIG. 5 is an exploded view of a connector shown in FIG. 4;

FIG. 6 is a local sectional view of a toothbrush head according to a first embodiment of the present disclosure;

FIG. 7 is a schematic diagram of a connection body of a connector shown in FIG. 5;

FIG. 8 is a schematic diagram of a connector shown in FIG. 4 from another perspective;

FIG. 9 is a front view of a brush head member of a toothbrush head according to a second embodiment of the present disclosure;

FIG. 10 is a sectional view of a brush head member of a toothbrush head shown in FIG. 9; and

FIG. 11 is an exploded view of a toothbrush head according to a second embodiment of the present disclosure.

### DETAILED DESCRIPTION OF THE EMBODIMENTS

The following detailed description of the preferred embodiments is of preferred modes for carrying out the present disclosure. This description is not intended to be limiting in any way. It is presented for the purpose of illustrating the general principles of the present disclosure.

It should be understood that to facilitate understanding of the present disclosure, the terms “installed”, “connected”, “coupled”, and “installed” in the following description refer to the connection relationships in the drawings. For example, the term “connected” may mean permanently connected or detachably connected. In addition, the term “connected” may also mean directly connected or indirectly connected, or connected through other auxiliary components. Therefore, the above terms should not be limiting on the actual connections of the elements in the present disclosure.

It should be understood that the terms “length”, “width”, “top”, “bottom”, “front”, “back”, “left”, “right”, “vertical”, “horizontal”, “upper”, “lower”, “outside”, and “inside” refer to the orientation or positioning relationships in the drawings to facilitate the understanding of the present disclosure, and do not limit the actual positions or orientations in the present disclosure. Therefore, the above terms should not be limiting on the actual positions of the elements in the present disclosure.

It should be understood that the terms “first”, “second”, “one”, “a/an”, and “one” in the following description refer to “at least one” or “one or more” in the embodiments. In particular, the term “a/an” may refer to “one” in one embodiment and to “more than one” in another embodiment. Therefore, the above terms should not be limiting on the actual numerals of the elements in the present disclosure.

To facilitate the understanding of the present disclosure, the present disclosure is described more completely below with reference to the accompanying drawings. Preferred embodiments of the represent disclosure are shown in the drawings. However, the present disclosure is embodied in various forms without being limited to the embodiments set forth herein. On the contrary, these examples are provided such that the disclosure of the present disclosure can be understood thoroughly and comprehensively.

### First Embodiment

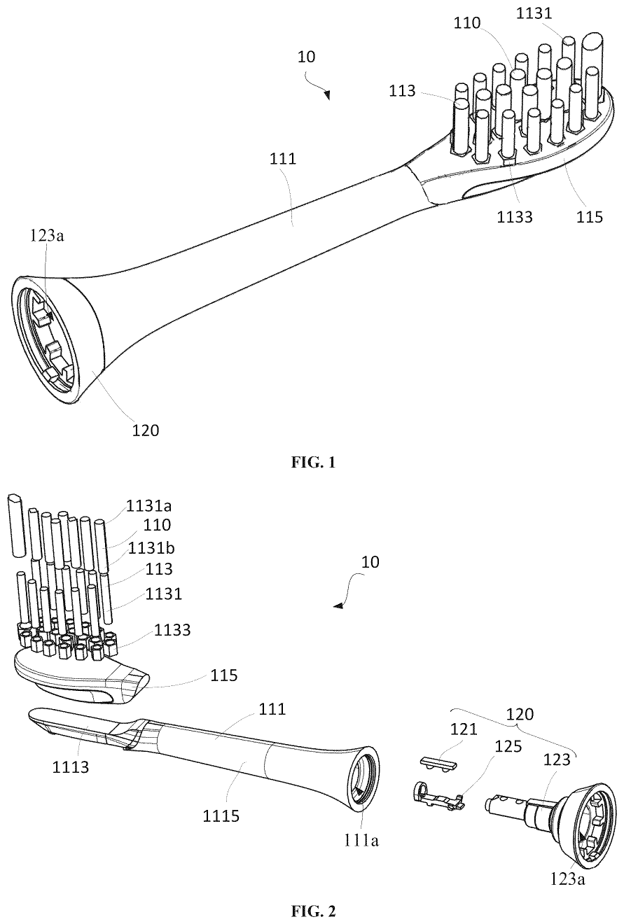

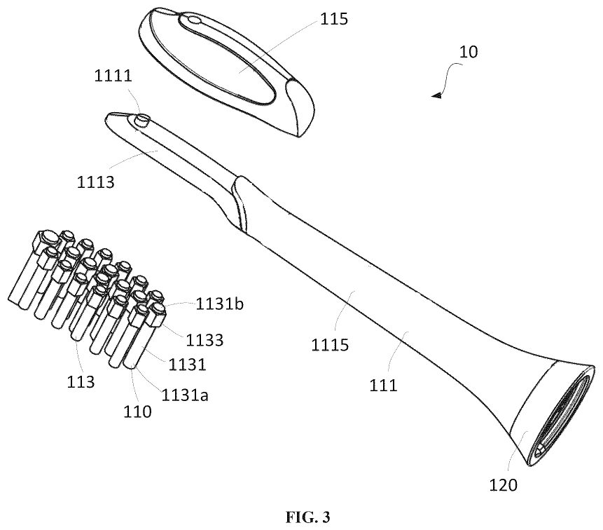

Referring to FIG. 1, FIG. 2, and FIG. 3, a first embodiment of the present disclosure provides a toothbrush head 10. The toothbrush head 10 includes a brush head member 110 and a connector 120 connected to one end of the brush head member 110. The brush head member 110 includes a hard brush handle 111 and brush bristle assemblies 113 connected to the hard brush handle 111. A connection hole 111a is formed in an end of the hard brush handle 111 facing away from the brush bristle assemblies 113.

The brush bristle assembly may include brush bristle bundles 1131 and fixing rings 1133. Each brush bristle bundle 1131 includes a free end 1131a and a fixed end 1131b that are opposite to each other. The brush bristle bundle 1131 passes through the corresponding fixing ring 1133, the fixed end 1131b is exposed from a side of the fixing ring 1133 away from the free end 1131a, the fixed end 1131b of any of the brush bristle bundles 1131 is integrally formed, the fixed ends 1131b of adjacent brush bristle bundles 1131 are arranged at intervals, adjacent fixing rings 1133 are arranged at intervals, and the hard brush handle 111 and the fixing rings 1133 are connected through a soft colloid 115 formed by injection molding.

The free ends 1131a of the brush bristle bundles 1131 can be in contact with teeth and perform a tooth brushing operation. Each brush bristle bundle 1131 may include a plurality of brush bristles, or may be an entire brush bristle. These brush bristles pass through the fixing rings 1133, the fixed ends 1131b and the free ends 1131a thereof respectively protrude from the fixing rings 1133, and heights of the free ends 1131a protruding from the fixing rings 1133 are greater than heights of the fixed ends 1131b protruding from the fixing rings 1133, such that users can clean oral cavities conveniently with the free ends 1131a. The fixed ends 1131b of the brush bristle bundles 1131 are hot-melted integrally, that is, the fixed ends 1131b of the brush bristle bundles 1131 are not completely received in the fixing rings 1133, and part of them protrude from the sides of the fixing rings 1133 distant from the free ends 1131a, to facilitate the hot-melting operation. The shape of the fixed ends 1131b after hot-melting may not be fixed. In other words, it is only necessary to hot-melt the sides of the brush bristle bundles 1131 protruding from the fixing rings 1133 distant from the free ends 1131a, to achieve fixed connection of a plurality of brush bristles and prevent the brush bristle bundles 1131 from easily escaping from the fixing rings 1133.

The cross-sectional shape of the fixing ring 1133 may be polygonal or circular, that is, the fixing ring 1133 may be a hollow prism or cylinder, which can prevent the brush bristle bundles 1131 from spreading out and maintain the bundle shape of the brush bristle bundles 1131. The fixing rings 1133 are arranged at intervals, and are connected to the hard brush handle 111 through a soft colloid 115 formed by injection molding. The brush bristle assemblies 113 are disposed on the hard brush handle 111, or there is a small gap between the brush bristle assemblies 113 and the hard brush handle 111, and then the brush bristle assemblies 113 are fixed through the soft colloid 115 by injection molding. The hard brush handle 111 can directly transmit vibration to the brush bristle bundles 1131 on the brush bristle assemblies 113, or transmit vibration to the brush bristle bundles 1131 on the brush bristle assemblies 113 through the soft colloid 115. The brush bristle assemblies 113 have a high degree of freedom of swinging and a soft touch.

By forming the brush bristle bundles 1131 into the brush bristle assemblies 113 through the fixing rings 1133, arranging the fixing rings 1133 at intervals on the hard brush handle 111, and implementing connection by injection molding of the soft colloid 115, when a motor of an electric toothbrush drives brush bristles to vibrate through the hard brush handle 111 and the soft colloid 115, the brush bristle assemblies 113, as independent units, have a relatively high degree of freedom of swinging in combination with deformation of the soft colloid 115, and therefore can adapt to changes in the angle of the toothbrush head 10 relative to teeth and the shapes of teeth surfaces. When the soft colloid 115 is in contact with the teeth, gums or the inner wall of the oral cavity, the soft colloid 115 feels softer, which can improve the comfort of tooth brushing.

Still referring to FIG. 1 and FIG. 2, the soft colloid 115 can cover at least part of the fixing ring 1133 and the whole fixed end 1131b. In other words, the fixed end 1131b of the brush bristle bundle 1131 is entirely encapsulated in the soft colloid 115, and at least part of the fixing ring 1133 is encapsulated in the soft colloid 115. Of course, in some other embodiments, the fixing ring 1133 can be completely encapsulated in the soft colloid 115, that is, the fixed end 1131b and the fixing ring 1133 are both encapsulated in the soft colloid 115.

Furthermore, referring to FIG. 3, a protruding anchor point 1111 may be provided at a top end of the hard brush handle 111, and the soft colloid 115 covers the top end of the hard brush handle 111. Specifically, the hard brush handle 111 includes a connection end 1113 and a transition end 1115 that are integrally formed, the connection end 1113 is narrower than the transition end 1115 at a junction of the connection end 1113 and the transition end 1115, that is, a stepped structure can be formed. The brush bristle assemblies 113 are fixed to the connection end 1113 through the soft colloid 115, the soft colloid 115 covers the entire connection end 1113, the transition end 1115 is provided with the connection hole 111a, and the protruding anchor point 1111 is located at the connection end 1113. The soft colloid 115 covers the entire connection end 1113, that is, an outer surface of the connection end 1113 is not exposed at a part where the connection end 1113 of the hard brush handle 111 is located, thereby preventing the connection end 1113 of the hard brush handle 111 from accidentally hitting the gums or teeth during the user's tooth brushing process and causing discomfort. The protruding anchor point 1111, the connection end 1113, and the transition end 1115 form a stepped structure, which can enhance the combination stability between the soft colloid 115 and the hard brush handle 111, and prevent the molten soft colloid from easily escaping from the hard brush handle 111 or becoming loose in an axial direction of the hard brush handle 111 after being solidified on the hard brush handle 111.

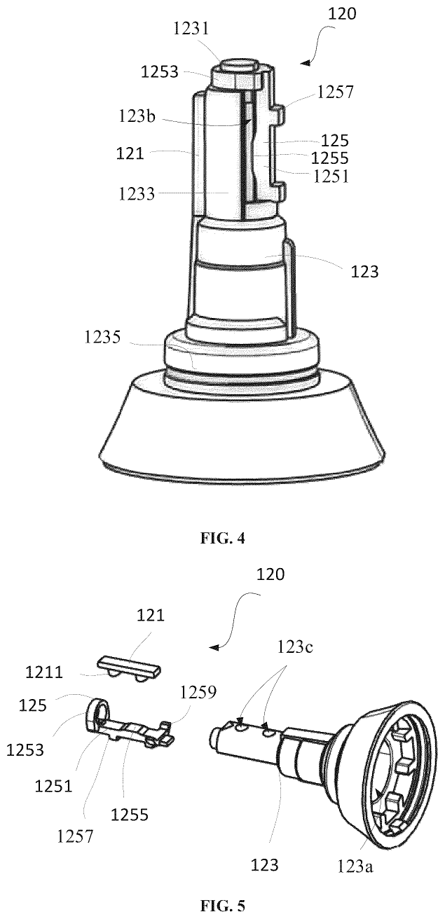

Referring to FIG. 2, FIG. 4, and FIG. 5, the connector 120 includes a soft clamping member 121 and a connection body 123. The soft clamping member 121 is embedded in the connection body 123. The connection body 123 is fixedly inserted in the connection hole 111a, that is, at least part of the connection body 123 is received in the connection hole 111a, and the connection body 123 is fixedly connected to the hard brush handle 111. A shaft hole 123a configured to insert a motor shaft is formed in the connection body 123. The soft clamping member 121 at least partially protrudes into the shaft hole 123a, and abuts against the motor shaft.

The soft clamping member 121 may be made of plastic, and the hardness thereof may be less than 77 HD. When the hardness of the plastic is greater than 77 HD, the plastic may be called hard plastic; and when the hardness of the plastic is not greater than 77 HD, the plastic is called a soft material. The motor shaft configured to provide vibration can be inserted into the shaft hole 123a of the connection body 123 to achieve the connection between the motor shaft and the connector 120, thereby transmitting the vibration from the motor shaft to the brush head member 110, and then to the brush bristle assemblies 113 of the brush head member 110. The soft clamping member 121 is embedded in the connection body 123. Specifically, the soft clamping member 121 can be injection-molded onto the connection body 123 to ensure that part of the material on the soft clamping member 121 protrudes from the shaft hole 123a of the connection body 123. When the motor shaft is inserted into the shaft hole 123a, the soft clamping member 121 is squeezed and elastically deformed to abut against the motor shaft, achieving a more secure connection between the two and increasing the friction between the two, preventing the motor shaft from easily escaping from the shaft hole 123a due to repeated high-frequency vibration.

According to the toothbrush head 10 provided by the present disclosure, by providing the soft clamping member 121 protruding into the shaft holes 123a, in the process of inserting the motor shaft into the shaft holes 123a, the soft clamping member 121 can be squeezed and deformed to adapt to the motor shaft, increasing the contact area, ensuring the clamping reliability of the motor shaft and the brush head member 110, and thus improving the reliability of an oral care device (such as an electric toothbrush) employing the toothbrush head 10. Moreover, the deformation of the soft clamping member 121 can reduce the processing accuracy requirement for the shaft hole 123a. The soft clamping member 121 can ensure, by deformation, that the motor shaft is stably maintained in the shaft hole 123a. When the user removes the toothbrush head 10 from the oral care device, the soft clamping member 121 can also be deformed under the squeezing action of the motor shaft, such that it is convenient for the user to remove the toothbrush head 10 from the motor shaft and replace the toothbrush head 10 with a new one.

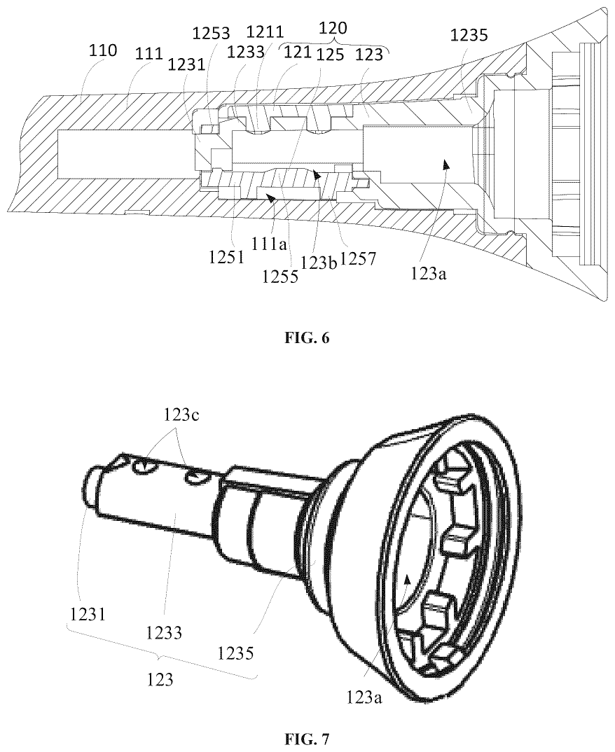

Referring to FIG. 4, FIG. 5, and FIG. 6, the connector 120 may further include a hard clamping member 125 provided in the connection hole 111a and fixedly clamped with the connection body 123, and the hard clamping member 125 is disposed on a side of the connection body 123 facing away from the shaft hole 123a. The hard clamping member 125 can facilitate fixed assembly of the connector 120 and the brush head member 110, and cooperate with the soft clamping member 121 to make the motor shaft and the connector 120 fit more tightly. The hard clamping member 125 may be made of hard plastic, that is, plastic having a hardness greater than 77 HD.

Specifically, referring to FIG. 6 and FIG. 7, in some implementations, the connection body 123 includes a shaft neck 1231, a shaft sleeve 1233, and a shaft seat 1235 that are integrally formed, the shaft neck 1231 is narrower than the shaft sleeve 1233, the shaft sleeve 1233 is narrower than the shaft seat 1235, and the shaft seat 1235 can be exposed outside the connection hole 111a. The shaft hole 123a extends from the shaft seat 1235 into the shaft sleeve 1233, and the soft clamping member 121 is connected to the shaft sleeve 1233.

Referring to FIG. 5, the hard clamping member 125 may include a support body 1251 and a connection ring 1253 connected to one end of the support body 1251, the connection ring 1253 is fixedly sleeved on the shaft neck 1231, and the support body 1251 is exposed to a side of the shaft sleeve 1233 facing away from the shaft hole 123a. In some implementations, the support body 1251 is disposed on one side of the shaft sleeve 1233, and the soft clamping member 121 is disposed on another side of the shaft sleeve 1233 opposite to the support body, to facilitate fixed connection of the hard clamping member 125, the soft clamping member 121, and the connection body 123. The connection ring 1253 of the hard clamping member 125 can facilitate pre-assembly of the hard clamping member 125 and the connection body 123. In the process of inserting the connector 120 into the connection hole 111a, the hard brush handle 111 presses the hard clamping member 125, such that the hard clamping member 125 is assembled in place on the connection body 123. Combined with the pressing action of the soft clamping member 121 and the hard brush handle 111, the connector 120 is reliably fixed to the hard brush handle 111.

Still referring to FIG. 4 and FIG. 6, in some implementations, the shaft sleeve 1233 may be provided with a first mounting groove 123b communicated with the shaft hole 123a, the support body 1251 is accommodated in the first mounting groove 123b and is provided with a connection protrusion 1255 on a side facing the shaft hole 123a, and the connection protrusion 1255 abuts against the motor shaft. On one hand, the provision of the first mounting groove 123b can better position the hard clamping member 125 on the connection body 123. The hard clamping member 125 is disposed in the recessed first mounting groove 123b, such that the position of the hard clamping member 125 is more stable. The connection protrusion 1255 protrudes from the first mounting groove 123b having a hollow bottom into the shaft hole 123a and can abut against the motor shaft. The connection protrusion 1255 and a soft colloid clamping member 121 squeeze two opposite sides of the motor shaft, improving the connection reliability of the motor shaft to the toothbrush head 10, and facilitating transfer of the vibration to the brush head member 110.

At least two butting protrusions 1257 spaced apart from each other are provided at a side of the support body 1251 facing away from the connection protrusion 1255, and the butting protrusions 1257 abut against a wall of the connection hole 111a. The hard clamping member 125 is tightly connected to the connection hole 111a through the butting protrusions 1257, and the hard clamping member 125 does not completely abut against the wall of the connection hole 111a. This allows the hard clamping member 125 and the wall of the connection hole 111a to have a definite abutting position, thereby reducing the assembly accuracy requirements for the connection hole 111a and the hard clamping member 125, facilitating the assembly of the connector 120 with the hard clamping member 125 and the brush head member 110, and enabling the hard clamping member 125 to be firmly connected in the connecting hole 111a.

In addition, to improve the connection stability between the hard clamping member 125 and the connection body 123, a protrusion 1259 protruding from the support body 1251 can be provided at the tail of the support body 1251 of the hard clamping member 125, i.e., an end opposite to the connection ring 1253. A corresponding slot is provided on the connection body 123, such that the protrusion 1259 can be inserted into the slot, preventing the hard clamping member 125 from rotating around the outer wall of a connection portion 2210 under high-frequency vibration, improving the connection stability of the hard clamping member 125 on the connection body 123.

Still referring to FIG. 5 and FIG. 7 in combination with FIG. 8, the connection body 123 is provided with through hole 123c communicated with the shaft hole 123c, and the soft clamping member 121 passes through the through holes 123c and extends in the shaft hole 123a along the through holes 123c to the side of the connection body 123 facing away from the shaft hole 123a. The provision of the through holes 123c is beneficial to the fixation of the soft clamping member 121 and the connection body 123, and is beneficial to the formation of the soft clamping member 121 on the connection body 123, thereby ensuring that the soft clamping member 121 is accurately arranged on the connection body 123 and can also protrude into the shaft hole 123a more conveniently.

Of course, in some implementations, the side of the connection body 123 facing away from the shaft hole 123a can be provided with a second mounting groove spaced apart from the shaft hole 123a, the second mounting groove can be arranged opposite to the first mounting groove 123b, the through holes 123c are formed in a bottom of the second mounting groove, and the soft clamping member 121 is disposed in the second mounting groove. This structural arrangement is more conducive to the formation of the soft clamping member 121 on the connection body 123, and prevents the soft clamping member 121 from sliding axially or circumferentially along the connection body 123, thereby ensuring the reliable fixation of the soft clamping member 121 and the connection body 123, and ensuring the abutment of the soft clamping member 121 and the motor shaft. It can be understood that the second mounting groove may be omitted.

There may be at least two through holes 123c arranged at intervals on the connection body 123. In the implementation in which the connection body 123 is provided with the second mounting groove, there may be at least two through holes 123c arranged at intervals at a bottom of the second mounting groove. The soft clamping member 121 is provided with two abutting convex columns 1211, and the two abutting convex columns 1211 pass through the two through holes 123c in one-to-one correspondence and protrude from the shaft hole 123a. At least two through holes 123c are formed in the bottom of the second mounting groove, and at least two abutting convex columns 1211 of the soft clamping member 121 can pass through the through holes 123c in one-to-one correspondence and abut against a side surface of the motor shaft. The cooperation between a plurality of through holes 123c and a plurality of abutting convex columns 1211 can make the soft connector 120 have a larger contact area with the motor shaft, making abutting regions more dispersed. When fewer abutting convex columns 1211 are provided, the soft connector 120 is reliably fixed to the connection body 123 and can reliably abut against the motor shaft.

### Second Embodiment

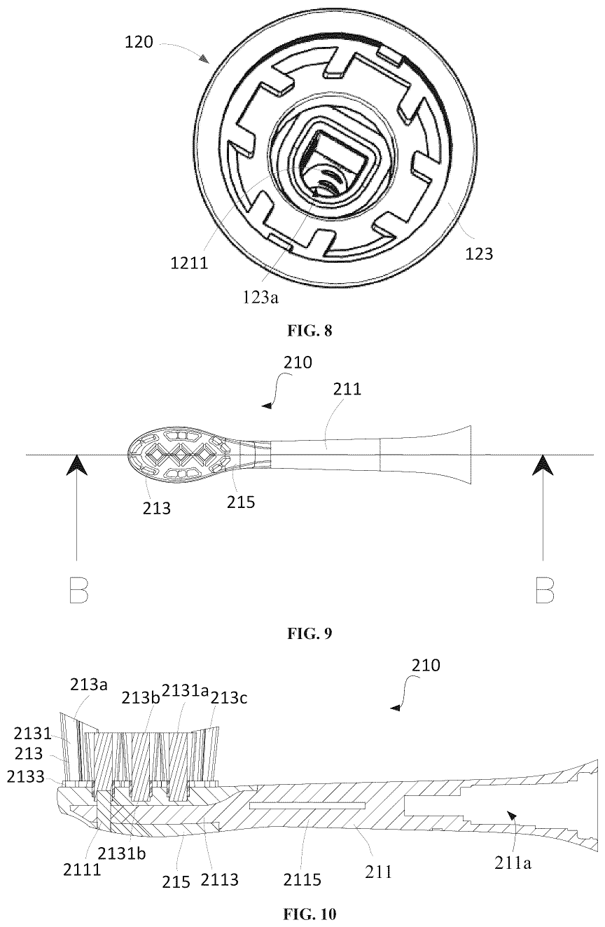

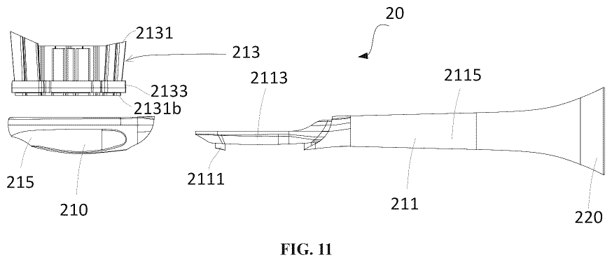

Referring to FIG. 9, FIG. 10, and FIG. 11, in a second embodiment of the present disclosure, the brush bristle assembly 213 of the brush head member 210 of the toothbrush head 20 may also include brush bristle bundles 2131 and fixing rings 2133. Each brush bristle bundle 2131 includes a free end 2131a and a fixed end 2131b that are opposite to each other. The brush bristle bundle 2131 passes through the corresponding fixing ring 2133, the fixed end 2131b is exposed from the side of the fixing ring 2133 away from the free end 2131a, the fixed end 2131b of any of the brush bristle bundles 2131 is integrally formed, the fixed ends 2131b of adjacent brush bristle bundles 2131 are arranged at intervals, adjacent fixing rings 2133 are arranged at intervals, the hard brush handle 211 and the fixing rings 2133 are connected through a soft colloid 215 formed by injection molding, and the hard brush handle 211 is also provided with a connection hole 211a configured to clamp a fixing connector 220.

In the second embodiment, the hard brush handle 211 may also include a connection end 2113 and a transition end 2115 that are integrally formed, the connection end 2113 is narrower than the transition end 2115 at a junction of the connection end 2113 and the transition end 2115, that is, a stepped structure can be formed. The brush bristle assemblies 213 are fixed to the connection end 2113 through the soft colloid 215, the soft colloid 215 covers the entire connection end 2113, the transition end 2115 is provided with the connection hole 211a, and the protruding anchor point 2111 is located at the connection end 2113. The soft colloid 215 covers the entire connection end 2113, that is, an outer surface of the connection end 2113 is not exposed at a part where the connection end 2113 of the hard brush handle 211 is located, thereby preventing the connection end 2113 of the hard brush handle 211 from accidentally hitting the gums or teeth during the user's tooth brushing process and causing discomfort. Reference may be made to the first embodiment for other structures of the brush head member 210, which will not be repeated herein.

Different from the first embodiment, in a direction from the connection end 2113 to the transition end 2115, the brush bristle bundle 2131 includes a first brush bristle region 213a, a second brush bristle region 213b, and a third brush bristle region 213c that are arranged in sequence, the first brush bristle region 213a and the third brush bristle region 213c are respectively disposed at two ends of the second brush bristle region 213b in a length direction of the hard brush handle 211 (i.e., the axial direction of the hard brush handle 211), and the first brush bristle region 213a and the second brush bristle region 213b respectively include at least two brush bristle assemblies 213. The free ends 2131a in the first brush bristle region 213a and the third brush bristle region 213c respectively protrude from the free ends 2131a in the second brush bristle region 213b, and end surfaces of the free ends 2131a in the first brush bristle region 213a and the third brush bristle region 213c are all inclined toward the second brush bristle region 213b. In other words, the free ends 2131a of the brush bristle bundles 2131 on the toothbrush head 20, i.e., the ends configured to perform a brushing operation, may have inconsistent heights, and a structure having two high ends and a low flat middle is adopted, such that a brushing operation surface of the toothbrush head 20 is a curved surface to better fit tooth contours, and the teeth are cleaned with high efficiency when the toothbrush head 20 vibrates at a high frequency.

Furthermore, heights of tail ends of the brush bristle bundles 2131 in the first brush bristle region 213a protruding from the fixing rings 2133 are greater than heights of tail ends of the brush bristle bundles 2131 in the third brush bristle region 213c protruding from the fixing rings 2133. The heights of the tail ends of the brush bristle bundles 2131 in the third brush bristle region 213c protruding from the fixing rings 2133 are greater than heights of tail ends of the brush bristle bundles 2131 in the second brush bristle region 213b protruding from the fixing rings 2133. The first brush bristle region 213a is located at a top end of the toothbrush head 20, is the highest, and can reach the innermost molars of the oral cavity more directly to clean the molars. The third brush bristle region 213c has a second height so as not to extend too far into outer tooth gaps when the first brush bristle region 213a is in contact with the teeth deep in the oral cavity, thereby ensuring that the toothbrush head 20 has the largest possible cleaning range while improving the brushing comfort.

The technical features of the foregoing embodiments can be employed in arbitrary combinations. For brevity of description, not all possible combinations of the technical features of the foregoing embodiments are described. However, the combinations of the technical features should be construed as falling within the scope described in this specification as long as there is no contradiction in the combinations.

The above embodiments only express several implementations of the present disclosure, and the descriptions thereof are relatively specific and detailed, but they should not be thereby interpreted as limiting the scope of the present disclosure. It should be noted that those of ordinary skill in the art can further make several variations and improvements without departing from the concept of the present disclosure, and all of these fall within the protection scope of the present disclosure. Therefore, the protection scope of the present disclosure shall be subject to the protection scope defined by the claims.

What is claimed is:

1. A toothbrush head, comprising:
a brush head member, comprising a hard brush handle and brush bristle assemblies connected to the hard brush handle, wherein a connection hole is formed in an end of the hard brush handle facing away from the brush bristle assemblies; and
a connector, comprising a soft clamping member and a connection body, wherein the connection body is accommodated in the connection hole and fixedly connected to the hard brush handle, a shaft hole configured to insert a motor shaft is formed in the connection body, and the soft clamping member is connected to the connection body, at least partially protrudes into the shaft hole, and abuts against the motor shaft.

2. The toothbrush head according to claim 1, wherein the connector comprises a hard clamping member provided in the connection hole and fixedly clamped with the connection body, and the hard clamping member is disposed on a side of the connection body facing away from the shaft hole.

3. The toothbrush head according to claim 2, wherein the connection body comprises a shaft neck and a shaft sleeve that are integrally formed, the shaft neck is narrower than the shaft sleeve, the shaft hole extends into the shaft sleeve, and the soft clamping member is connected to the shaft sleeve; and the hard clamping member comprises a support body and a connection ring connected to one end of the support body, the connection ring is fixedly sleeved on the shaft neck, and the support body is exposed to a side of the shaft sleeve facing away from the shaft hole.

4. The toothbrush head according to claim 3, wherein the support body is disposed on one side of the shaft sleeve, and the soft clamping member is disposed on another side of the shaft sleeve opposite to the support body.

5. The toothbrush head according to claim 3, wherein the shaft sleeve is provided with a first mounting groove communicated with the shaft hole, the support body is accommodated in the first mounting groove and is provided with a connection protrusion on a side facing the shaft hole, and the connection protrusion abuts against the motor shaft.

6. The toothbrush head according to claim 5, wherein at least two butting protrusions spaced apart from each other are provided at a side of the support body facing away from the connection protrusion, and the butting protrusions abut against a wall of the connection hole.

7. The toothbrush head according to claim 3, wherein the connection body comprises a base integrally formed with the shaft sleeve, and the base is exposed outside the connection hole.

8. The toothbrush head according to claim 2, wherein the connection body is provided with through holes communicated with the shaft hole, and the soft clamping member passes through the through holes and extends in the shaft hole along the through holes to the side of the connection body facing away from the shaft hole.

9. The toothbrush head according to claim 8, wherein the side of the connection body facing away from the shaft hole is provided with a second mounting groove spaced apart from the shaft hole, the through holes are formed in a bottom of the second mounting groove, and the soft clamping member is disposed in the second mounting groove.

10. The toothbrush head according to claim 9, wherein there are at least two through holes spaced apart from each other at the bottom of the second mounting groove, the soft clamping member is provided with two abutting convex columns, and the two abutting convex columns pass through the two through holes in one-to-one correspondence and protrude from the shaft hole.

11. The toothbrush head according to claim 1, wherein the brush bristle assembly comprises brush bristle bundles and fixing rings, each brush bristle bundle comprises a free end and a fixed end that are opposite to each other, the brush bristle bundle passes through the corresponding fixing ring, the fixed end is exposed from a side of the fixing ring away from the free end, the fixed end of any of the brush bristle bundles is integrally formed, the fixed ends of adjacent brush bristle bundles are arranged at intervals, adjacent fixing rings are arranged at intervals, and the hard brush handle and the fixing rings are connected through a soft colloid formed by injection molding.

12. The toothbrush head according to claim 11, wherein the fixed end and the free end respectively protrude from the fixing ring, and a height of the free end protruding from the fixing ring is greater than a height of the fixed end protruding from the fixing ring.

13. The toothbrush head according to claim 11, wherein the soft colloid covers at least part of the fixing ring and the whole fixed end.

14. The toothbrush head according to claim 11, wherein the fixing ring has a polygonal or circular cross section.

15. The toothbrush head according to claim 11, wherein a protruding anchor point is provided at a top end of the hard brush handle, and the soft colloid covers the top end of the hard brush handle.

16. The toothbrush head according to claim 15, wherein the hard brush handle comprises a connection end and a transition end that are integrally formed, the connection end is narrower than the transition end at a junction of the connection end and the transition end, the brush bristle assemblies are fixed to the connection end through the soft colloid, the soft colloid covers the entire connection end, the transition end is provided with the connection hole, and the protruding anchor point is located at the connection end.

17. The toothbrush head according to claim 16, wherein in a direction from the connection end to the transition end, the brush bristle bundle comprises a first brush bristle region, a second brush bristle region, and a third brush bristle region that are arranged in sequence, the first brush bristle region and the third brush bristle region are respectively disposed at two ends of the second brush bristle region in a length direction of the hard brush handle, and the first brush bristle region and the second brush bristle region respectively comprise at least two brush bristle assemblies.

18. The toothbrush head according to claim 17, wherein the free ends in the first brush bristle region and the third brush bristle region respectively protrude from the free ends in the second brush bristle region, and end surfaces of the free ends in the first brush bristle region and the third brush bristle region are all inclined toward the second brush bristle region.

19. The toothbrush head according to claim 18, wherein heights of tail ends of the brush bristle bundles in the first brush bristle region protruding from the fixing rings are greater than heights of tail ends of the brush bristle bundles in the third brush bristle region protruding from the fixing rings, and the heights of the tail ends of the brush bristle bundles in the third brush bristle region protruding from the fixing rings are greater than heights of tail ends of the brush bristle bundles in the second brush bristle region protruding from the fixing rings.
